(19) United States
(12) Patent Application Publication
(10) Pub. No.: US 2010/0007909 A1
(43) Pub. Date: Jan. 14, 2010

(54) METHOD AND APPARATUS FOR DELETING SECURE PRINT JOBS

(75) Inventor: Andrew J. AIKENS, Webster, NY (US)

Correspondence Address: Prass LLP, 2661 Riva Road, Building 1000, Suite 1044, Annapolis, MD, 21401, US

(73) Assignee: XEROX CORPORATION, Norwalk, CT (US)

(21) Appl. No.: 12/168,998

(22) Filed: Jul. 8, 2008

(51) Int. Cl. G06F 3/12

(52) U.S. Cl. 358/1.15

(57) ABSTRACT

A method and apparatus for deleting secure print jobs sent to an image production device is disclosed. The method may include receiving a secure print job and secure print job delete instructions from a user that include a secure print job expiration time, setting a secure print job delete timer based on the secure print job expiration time, determining if the secure print job delete timer has expired, wherein if it is determined that the secure print job delete timer has expired, deleting the secure print job, otherwise determining if the secure print job has been printed, wherein if it is determined that the secure print job has been printed, the secure print job delete timer is set to zero.

### BACKGROUND

Disclosed herein are a method for deleting secure print jobs sent to an image production device, as well as corresponding apparatus and computer-readable medium.

Most current printers and multifunctional devices support a secure print feature. The secure print feature may allow users to protect a confidential document that they may not want others to view or take, by requiring the user to be at the image production device when the print job prints out. In most use cases, the user selects this function, and then walks to the device to release the job. However, some users may leave the print job on the device for an extended period of time (e.g., forget about the print job, send it to the wrong printer, etc.).

In conventional devices, the print job will stay resident on the image production device until it is either released or deleted by the authorized user at the image production device user interface or manually deleted by a system administrator. The issue with this implementation is that the user does not have any time limits in which he or she must release or delete their secure print job(s). Thus, the secure print job(s) could literally reside in the memory of the image production device indefinitely. This issue may pose a security risk depending upon the security policies of the organization.

### SUMMARY

A method and apparatus for deleting secure print jobs sent to an image production device is disclosed. The method may include receiving a secure print job and secure print job delete instructions from a user that include a secure print job expiration time, setting a secure print job delete timer based on the secure print job expiration time, determining if the secure print job delete timer has expired, wherein if it is determined that the secure print job delete timer has expired, deleting the secure print job, otherwise determining if the secure print job has been printed, wherein if it is determined that the secure print job has been printed, the secure print job delete timer is set to zero.

### BRIEF DESCRIPTION OF THE DRAWINGS

FIG. 1 is an exemplary diagram of an image production environment in accordance with one possible embodiment of the disclosure;

FIG. 2 is an exemplary block diagram of an image production device in accordance with one possible embodiment of the disclosure;

FIG. 3 is a flowchart of an exemplary secure print job delete process in accordance with one possible embodiment of the disclosure; and

FIG. 4 is a block diagram of a secure print job user interface in accordance with one possible embodiment of the disclosure.

### DETAILED DESCRIPTION

Aspects of the embodiments disclosed herein relate to a method for high capacity stacking and stitching in an image production device, as well as corresponding apparatus and computer-readable medium.

The disclosed embodiments may include a method for deleting secure print jobs sent to an image production device is disclosed. The method may include receiving a secure print job and secure print job delete instructions from a user that include a secure print job expiration time, setting a secure print job delete timer based on the secure print job expiration time, determining if the secure print job delete timer has expired, wherein if it is determined that the secure print job delete timer has expired, deleting the secure print job, otherwise determining if the secure print job has been printed, wherein if it is determined that the secure print job has been printed, the secure print job delete timer is set to zero.

The disclosed embodiments may further include an image production device that may include a memory, and a secure print manager that receives a secure print job and secure print job delete instructions from a user and stores the secure print job in the memory, wherein the secure print job delete instructions include a secure print job expiration time, sets a secure print job delete timer based on the secure print job expiration time, determines if the secure print job delete timer has expired, wherein if the secure print manager determines that the secure print job delete timer has expired, the secure print manager deletes the secure print job from the memory, otherwise the secure print manager determines if the secure print job has been printed, wherein if the secure print manager determines that the secure print job has been printed, the secure print manager sets the secure print job delete timer is set to zero.

The disclosed embodiments may further include a method for providing instructions to an image production device for deleting secure print jobs. The method may include receiving a signal from a user to print a secure print job, prompting the user to enter a pass code, prompting the user to enter secure print job delete instructions, the secure print job delete instructions including a secure print job expiration time, the secure print job expiration time being an amount of time before the secure print job is to be deleted by the image production device, and sending the secure print job, the pass code, and the secure print job expiration time to the image production device.

This disclosure may concern adding an option to allow a user to select a time period after which a secure print job would be automatically deleted by the image production device if it is not released or deleted at the image production device user interface by the authorized user. Additionally, a system administrator may be given the ability to select a time period to automatically delete unreleased secure print jobs.

In particular, this function may allow the authorized user to select a time period (for example 1 hour) after which their secure print job would be automatically deleted by the image production device if it has not been released or deleted by the authorized user. This feature may be accomplished via extending the functionality of the current secure print driver dialog box. Thus, the user may have the option to vary the time for each individual secure print job.

In addition, there may be a configuration setting available to allow the system administrator to set the duration for how long any secure print job will be held until it is automatically deleted. Some restrictions may be enabled in the driver as to not allow the user to select a time period which is longer than the one set by the system administrator, for example. The duration may also be set as a default value by the manufacturer, for example.

An image production device with the secure print delete function discussed herein has many advantages over conventional systems, including improved security and improved operability.

Improved security: In conventional image production devices, a secure print job could be compromised by an unauthorized user. In these devices, any user can view the pending print job queue, which includes secure print jobs. In addition, there is no limit to the number of attempts an unauthorized user can try to release a secure print job. Thus, since there is no time limit to the duration of how long the secure print is stored on the device, an unauthorized individual could have unlimited time to attempt to release another person's secure print job.

Depending upon the security features on the image production device (e.g., firewall, data encryption, etc.) the secure print could also be compromised (or accessed) by a remote unauthorized user (i.e., a hacker). In effect, the longer a secure print job is held by the image production device, the less secure it becomes since the probability of an unauthorized user attempting to release or access it increases.

By implementing a user or system administrator selectable time delete duration (for example 1 hour) as discussed herein, the time duration in which the secure print job is available is dramatically decreased, along with the risk of compromise by an unauthorized user.

Improved operability: In addition to improved security, the secure print job delete function may have improved operability benefits as well. Using this function, the system administrator may not have to periodically manually delete old, unreleased secure print jobs from the various image production devices they manage. Also, users would not have to be concerned about leaving a secure print job on an image production device for an extended period of time.

FIG. 1 is an exemplary diagram of an image production environment 100 in accordance with one possible embodiment of the disclosure. The image production environment 100 may include a processing device 110 that may be hardwired or Tirelessly connected to an image production device 120.

The processing device 110 may be any device capable to sending a print job to an image production device 120, including a computer, a server, a telephone, or a personal digital assistant, for example. The image production device 120 may be any device that may be capable of printing documents, including a printer, a copier/printer, an office copier/printer, a high-capacity copier/printer, a commercial copier/printer, a facsimile/printer device, or a multi-function device, for example.

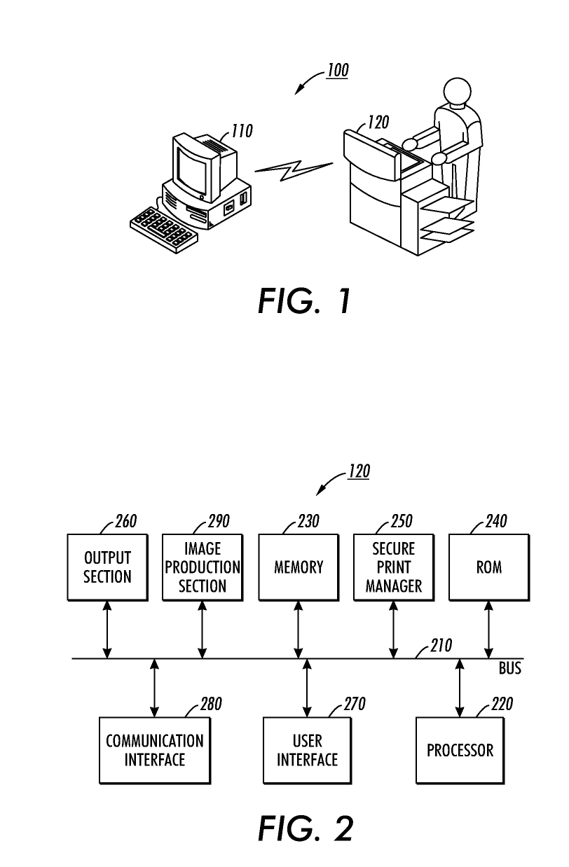

FIG. 2 is an exemplary block diagram of an image production device 120 in accordance with one possible embodiment of the disclosure. The image production device 120 may include a bus 210, a processor 220, a memory 230, a read only memory (ROM) 240, a secure print manager 250, an output section 260, a user interface 270, a communication interface 280, and an image production section 290. Bus 210 may permit communication among the components of the image production device 120.

Processor 220 may include at least one conventional processor or microprocessor that interprets and executes instructions. Memory 230 may be a random access memory (RAM) or another type of dynamic storage device that stores information and instructions for execution by processor 220. Memory 230 may also include a read-only memory (ROM) which may include a conventional ROM device or another type of static storage device that stores static information and instructions for processor 220.

Communication interface 280 may include any mechanism that facilitates communication via a network. For example, communication interface 280 may include a modem. Alternatively, communication interface 280 may include other mechanisms for assisting in communications with other devices and/or systems.

ROM 240 may include a conventional ROM device or another type of static storage device that stores static information and instructions for processor 220. A storage device may augment the ROM and may include any type of storage media, such as, for example, magnetic or optical recording media and its corresponding drive.

User interface 270 may include one or more conventional mechanisms that permit a user to input information to and interact with the image production unit 100, such as a keyboard, a display, a mouse, a pen, a voice recognition device, touchpad, buttons, etc., for example. Output section 260 may include one or more conventional mechanisms that output image production documents to the user, including output trays, output paths, finishing section, etc., for example. The image production section 290 may include an image printing section, a scanner, a toner section, etc., for example.

The image production device 120 may perform such functions in response to processor 220 by executing sequences of instructions contained in a computer-readable medium, such as, for example, memory 230. Such instructions may be read into memory 230 from another computer-readable medium, such as a storage device or from a separate device via communication interface 280.

The image production device 120 illustrated in FIGS. 1-2 and the related discussion are intended to provide a brief, general description of a suitable communication and processing environment in which the disclosure may be implemented. Although not required, the disclosure will be described, at least in part, in the general context of computer-executable instructions, such as program modules, being executed by the image production device 120, such as a communication server, communications switch, communications router, or general purpose computer, for example.

Generally, program modules include routine programs, objects, components, data structures, etc. that perform particular tasks or implement particular abstract data types. Moreover, those skilled in the art will appreciate that other embodiments of the disclosure may be practiced in communication network environments with many types of communication equipment and computer system configurations, including personal computers, hand-held devices, multi-processor systems, microprocessor-based or programmable consumer electronics, and the like.

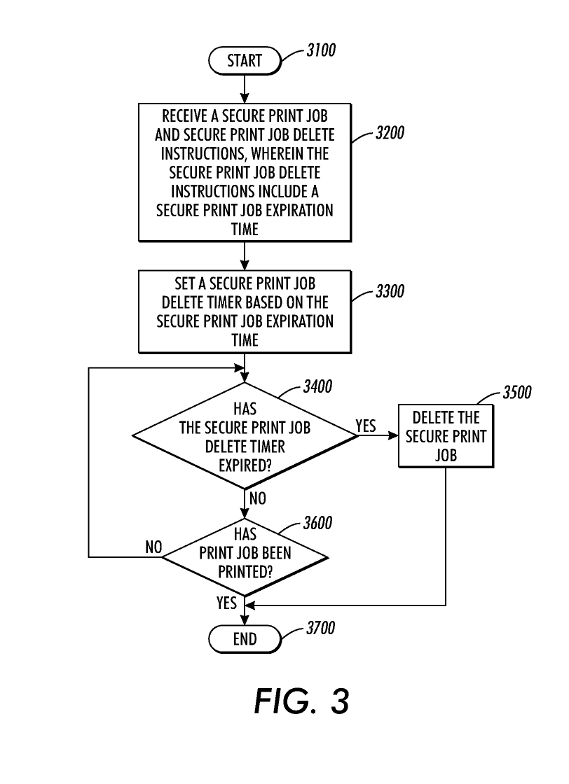

For illustrative purposes, the operation of the secure print manager 250 and the exemplary the secure print job delete process are described in FIG. 3 in relation to the block diagrams shown in FIGS. 1-2.

FIG. 3 is a flowchart of an exemplary secure print job delete process in accordance with one possible embodiment of the disclosure; and

The method begins at 3100, and continues to 3200 where the secure print manager 250 may receive a secure print job and secure print job delete instructions from a user and stores the secure print job in the memory. The secure print job delete instructions may include a secure print job expiration time at the end of which the secure print job will be deleted.

At step 3300, the secure print manager 250 may set a secure print job delete timer based on the received secure print job expiration time. At step 3400, the secure print manager 250 may determine if the secure print job delete timer has expired. If at step 3400, the secure print manager 250 determines that the secure print job delete timer has expired, then at step 3500, the secure print manager 250 may delete the secure print job from memory 330. The process may then go to step 3700 and end.

However, if at step 3400, the secure print manager 250 determines that the secure print job delete timer has not expired, then at step 3600, the secure print manager 250 may determine that if the secure print job has been printed. If at step 3600 the secure print manager 250 determines that the secure print job has been printed, then at step 3700, the secure print manager 250 may set the secure print job delete timer to zero and the process ends. If at step 3600 the secure print manager 250 determines that the secure print job has not been printed, the process may return to step 3400.

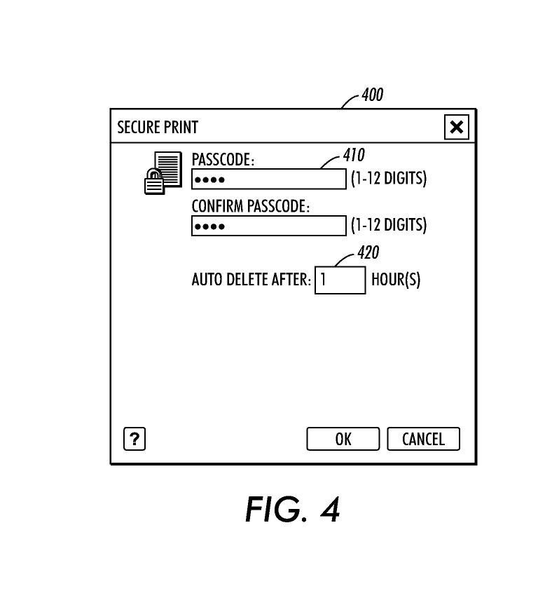

FIG. 4 is an exemplary diagram of a secure print job user interface 400 in accordance with one possible embodiment of the disclosure. The secure print job user interface 400 may be presented using a processing device 110, such as computer, a server, a telephone, or a personal digital assistant, for example, and may include areas where the user can enter secure print job delete instructions. In particular, the secure print job user interface 400 may include an area that prompts the user to enter (and confirm) a pass code 410, and an area that prompts the user to enter an amount of time that must expire 420 before the image production device 120 deletes the secure print job. The secure print job and the secure print job delete instructions, including the pass code 410 and the secure print job expiration time 420 may be sent to the image production device 120.

At the image production device 120, the secure print manager 250 may prompt the user at the user interface 270 to enter the pass code 410 that the user previously entered using the secure print job user interface 400 and may determine if the pass code is correct. If the secure print manager 250 determines that the pass code is correct, the secure print manager 250 may enable the secure print job to be printed.

If the user does not enter a secure print job expiration time 420, the secure print manager 250 may set a default secure print job expiration time, chosen by either of an administrator or the manufacturer, for example. In this manner, the secure print manager 250 may delete the secure print job upon expiration of the default secure print job expiration time.

The secure print manager 250 may send various notifications to the user concerning a secure print job, including that the secure print job delete timer will soon expire, that another user attempted to print the user's secure print job, and that the secure print job has been deleted.

The processing device 110 may also receive a request from the user to modify the secure print job delete instructions. In this manner, the processing device 110 may prompt the user to enter the pass code 410 previously entered at the secure print job user interface 400. If the pass code is entered correctly, the processing device 110 may prompt the user to modify the secure print job delete instructions. Once the secure print job delete instructions are modified, they may be sent to the image production device 120.

Embodiments as disclosed herein may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, and the like that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described therein. It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method for deleting secure print jobs sent to an image production device, comprising:
receiving a secure print job and secure print job delete instructions from a user, wherein the secure print job delete instructions include a secure print job expiration time;
setting a secure print job delete timer based on the secure print job expiration time;
determining if the secure print job delete timer has expired, wherein if it is determined that the secure print job delete timer has expired,
deleting the secure print job, otherwise
determining if the secure print job has been printed, wherein if it is determined that the secure print job has been printed, the secure print job delete timer is set to zero.

2. The method of claim 1, further comprising:
notifying the user that the secure print job delete timer will soon expire.

3. The method of claim 1, further comprising:
notifying the user that another user attempted to print the user's secure print job.

4. The method of claim 1, further comprising:
prompting the user to enter a pass code;
determining if the pass code is correct, wherein if it is determined that the pass code is correct,
printing the secure print job.

5. The method of claim 1, further comprising:
notifying the user if the secure print job is deleted.

6. The method of claim 1, wherein if no secure print job expiration time is received,
setting a default secure print job expiration time chosen by one of an administrator and a manufacturer, wherein the secure print job is deleted upon expiration of the default secure print job expiration time.

7. The method of claim 1, wherein the image production device is one of a printer, a copier/printer, an office copier/printer, a high-capacity copier/printer, a commercial copier/printer, a facsimile/printer device, and a multi-function device.

8. An image production device, comprising:
a memory; and
a secure print manager that receives a secure print job and secure print job delete instructions from a user and stores the secure print job in the memory, wherein the secure print job delete instructions include a secure print job expiration time, sets a secure print job delete timer based on the secure print job expiration time, determines if the secure print job delete timer has expired, wherein if the secure print manager determines that the secure print job delete timer has expired, the secure print manager deletes the secure print job from the memory, otherwise the secure print manager determines if the secure print job has been printed, wherein if the secure print manager determines that the secure print job has been printed, the secure print manager sets the secure print job delete timer is set to zero.

9. The image production device of claim 8, wherein the secure print manager notifies the user that the secure print job delete timer will soon expire.

10. The image production device of claim 8, wherein the secure print manager notifies the user that another user attempted to print the user's secure print job.

11. The image production device of claim 8, wherein the secure print manager prompts the user to enter a pass code, determines if the pass code is correct, wherein if the secure print manager determines that the pass code is correct, the secure print manager prints the secure print job.

12. The image production device of claim 8, wherein the secure print manager notifies the user if the secure print job is deleted.

13. The image production device of claim 8, wherein if no secure print job expiration time is received, the secure print manager sets a default secure print job expiration time chosen by one of an administrator and a manufacturer, wherein the secure print manager deletes the secure print job upon expiration of the default secure print job expiration time.

14. The image production device of claim 8, wherein the image production device is one of a printer, a copier/printer, an office copier/printer, a high-capacity copier/printer, a commercial copier/printer, a facsimile/printer device, and a multi-function device.

15. A method for providing instructions to an image production device for deleting secure print jobs, comprising:
receiving a signal from a user to print a secure print job;
prompting the user to enter a pass code;
prompting the user to enter secure print job delete instructions, the secure print job delete instructions including a secure print job expiration time, the secure print job expiration time being an amount of time before the secure print job is to be deleted by the image production device; and
sending the secure print job, the pass code, and the secure print job expiration time to the image production device.

16. The method of claim 15, further comprising:
receiving a request from the user to modify the secure print job delete instructions;
prompting the user to enter the pass code, wherein if the pass code is entered correctly,
prompting the user to modify the secure print job delete instructions; and
sending the modified secure print job delete instructions to the image production device.

17. The method of claim 15, further comprising:
receiving a notification from the image production device that the print job has been deleted.

18. The method of claim 15, further comprising:
receiving a notification from the image production device that another user attempted to print the user's secure print job.

19. The method of claim 15, further comprising:
receiving a notification from the image production device that the secure print job delete timer will soon expire.

20. The method of claim 15, wherein the secure print job delete instructions are sent to the image production device from one of a computer, a server, a telephone, and a personal digital assistant.
